(19) United States
(12) Patent Application Publication
(10) Pub. No.: US 2013/0207893 A1
(43) Pub. Date: Aug. 15, 2013

(54) POSITIONING INPUT SYSTEM WITH WIRELESS CHARGING FUNCTION, AND DEVICE

(71) Applicant: Kye Systems CORP., (US)

(72) Inventors: Chih-Min LIU, New Taipei (TW); Chih-Ming LIU, New Taipei (TW)

(73) Assignee: KYE SYSTEMS CORP., New Taipei (TW)

(21) Appl. No.: 13/845,566

(22) Filed: Mar. 18, 2013

Related U.S. Application Data
(63) Continuation-in-part of application No. 12/457,997, filed on Jun. 29, 2009.

(30) Foreign Application Priority Data
Apr. 29, 2009 (TW) 098114274

(51) Int. Cl. H02J 7/02

(52) U.S. Cl. CPC H02J 7/025
USPC 345/157

(57) ABSTRACT

A positioning input system with a wireless charging function, and a device thereof receive a frequency signal sent by a tablet and transmit an sensing signal to the tablet, wherein a rectifier circuit receives the frequency signal inducted by a sensing coil set, including a first sensing coil and a second sensing coil, to output electricity, the first sensing coil is non-connected, the second sensing coil is connected to the rectifier circuit, an oscillator circuit is connected to the rectifier circuit for receiving the electricity and outputting the sensing signal, and a third sensing coil transmits the sensing signal to the tablet. When the wireless positioning device is moved toward the tablet, a magnetic coupling occurs to the first sensing coil and the second sensing coil. The second sensing coil obtains an additional voltage used for supplying a stable operating voltage for the wireless positioning device.

### CROSS-REFERENCE TO RELATED APPLICATIONS

This non-provisional application is a continuation-in-part patent application of U.S. application Ser. No. 12/457,997 filed on Jun. 29, 2009, which claims priority under 35 U.S.C. § 119(a) on Patent Application No. 098114274 filed in Taiwan, R.O.C. on Apr. 29, 2009, the entire contents of which are hereby incorporated by reference.

### BACKGROUND OF THE INVENTION

1. Field of the Invention

The disclosure relates to an input apparatus, and more particularly to a positioning input system with a wireless charging function, and a device thereof.

2. Related Art

Tablets in the market are used with a wireless positioning element. The wireless positioning element will generate an electromagnetic field when contacting with a tablet, so that the tablet is enabled to compute the current coordinate location of the wireless positioning element according to the magnetic coupling manner. The coordinate location is then transmitted to a computer.

Recently, the electricity required by the wireless positioning element can be obtained in two ways. One of the two ways is a battery, and the other one is electricity formed by electromagnetic resonance. It is required to replace the battery frequently if the electricity is from the battery, which is extremely inconvenient for users and environmentally unfriendly. Therefore, the electromagnetic resonance manner is the most suitable way until now.

In the related technologies of supplying power through the electromagnetic resonance between the wireless positioning element and the tablet, the tablet is required to form a large magnetic field for the wireless positioning element to receive. The wireless positioning element will transmit the accumulated energy to the tablet after accumulated a certain amount of the energy. However, an amount of electricity generated by such a wireless charging manner is not fixed, so that operation interruptions may occur to the wireless positioning element.

### SUMMARY OF THE INVENTION

A positioning input system with a wireless charging function in the disclosure includes a tablet and a wireless positioning device. The tablet computes a corresponding coordinate location of the wireless positioning device according to a sensing signal. The tablet includes a signal processing circuit, a first antenna loop and a second antenna loop.

The signal processing circuit is used for outputting a frequency signal. The first antenna loop is electrically connected to the signal processing circuit. The first antenna loop is used for transmitting the frequency signal. The second antenna loop is electrically connected to the signal processing circuit. The second antenna loop is used for receiving the sensing signal. The wireless positioning device includes a sensing coil set, a rectifier circuit, an oscillator circuit and a third sensing coil.

The sensing coil set includes at least one first sensing coil and a second sensing coil. The rectifier circuit receives the frequency signal through the sensing coil set. The first sensing coil inducts the frequency signal to output a magnetic coupling signal. The second sensing coil inducts the frequency signal and the magnetic coupling signal to output electricity. The oscillator circuit is electrically connected to the rectifier circuit. The oscillator circuit is used for receiving the electricity outputted by the rectifier circuit, and for outputting the sensing signal. The third sensing coil is electrically connected to the oscillator circuit. The third sensing coil is used for transmitting the sensing signal.

A positioning input device with a wireless charging function in the disclosure includes a sensing coil set, a rectifier circuit, an oscillator circuit and a third sensing coil. The sensing coil set at least includes a first sensing coil and a second sensing coil. The first sensing coil inducts a frequency signal to output a magnetic coupling signal. The second sensing coil inducts the frequency signal and the magnetic coupling signal to output electricity. The rectifier circuit receives the frequency signal through the sensing coil set. The oscillator circuit is electrically connected to the rectifier circuit. The oscillator circuit is used for receiving the electricity outputted by the rectifier circuit, and for outputting the sensing signal. The third sensing coil is electrically connected to the oscillator circuit. The third sensing coil is used for transmitting the sensing signal.

### BRIEF DESCRIPTION OF THE DRAWINGS

The disclosure will become more fully understood from the detailed description given herein below for illustration only, and thus are not limitative of the disclosure, and wherein:

FIG. 1 is a schematic outside view of a tablet and a wireless positioning device according to an embodiment of the disclosure;

FIG. 2 is a schematic view of circuit structures of a tablet and a wireless positioning device according to an embodiment of the disclosure;

FIG. 3 is a schematic view of circuit structures of a tablet and a wireless positioning device according to an embodiment of the disclosure;

FIG. 4 is a schematic diagram of circuit structures of a tablet and a wireless positioning device according to an embodiment of the disclosure;

FIG. 5 is a schematic diagram of circuit structures of a tablet and a wireless positioning device according to an embodiment of the disclosure; and

FIG. 6 is a schematic diagram of circuit structures of a tablet and a wireless positioning device according to an embodiment of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

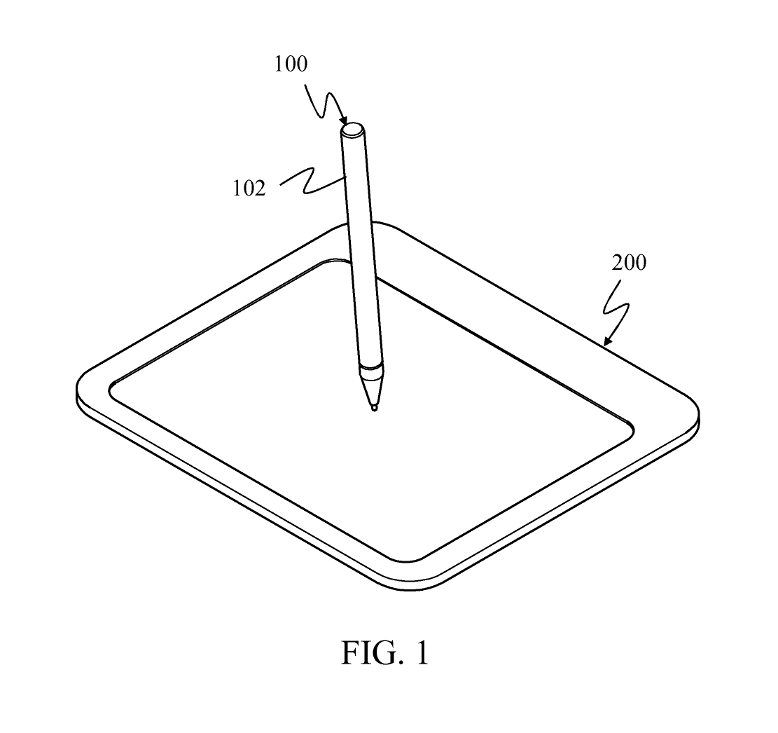

The disclosure relates to a positioning input system with a wireless charging function (battery-free) as shown in FIG. 1. The positioning input system includes a wireless positioning device 100 and a tablet 200. The wireless positioning device 100 can be a wireless positioning pen, a wireless mouse or other wireless pointing devices. The operation between the wireless positioning device 100 and the tablet 200 is described as follows.

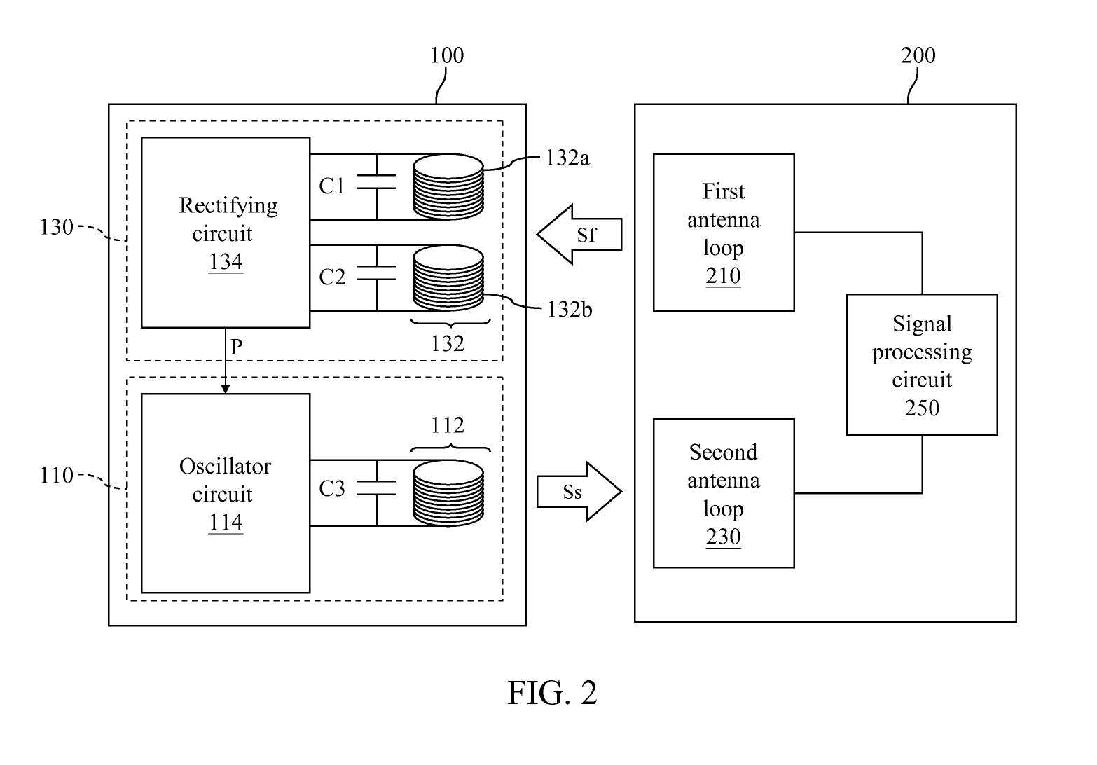

FIG. 2 is a schematic view of circuit structures of a tablet and a wireless positioning device according to an embodiment of the disclosure. The wireless pointing device 100 at least includes a power supply circuit 130 and a sensing circuit 110. When the wireless positioning device 100 moves in a sensing range of the tablet 200, the wireless positioning device 100 will receive a frequency signal Sf transmitted by the tablet 200. The wireless positioning device 100 performs electromagnetic induction according to the frequency signal Sf to generate electricity for the wireless positioning device 100, and transmits a corresponding location signal to the tablet 200. The wireless positioning device 100 senses the frequency signal Sf to generate electricity, and simultaneously transmits the location signal to the tablet 200.

The power supply circuit 130 includes a sensing coil set 133 and a rectifying circuit 134. The sensing coil set 133 includes a plurality of sensing coils 132 (the second sensing coils), e.g. the first sensing coil 132a and the second sensing coil 132b. The first sensing coil 132a is adjacent to the second sensing coil 132b, and both the first sensing coil 132a and the second sensing coil 132b are connected to the rectifying circuit 134. The rectifying circuit 134 is connected to the sensing coils 131. A first capacitor C1 is coupled between two ends of the first sensing coil 132a, and a second capacitor C2 is coupled between two ends of the second sensing coil 132b.

In the power supply circuit 130, the sensing coils 132 wirelessly receives the frequency signal Sf emitted from the tablet 200 and forms a mutual electromagnetic resonance therebetween through the frequency signal Sf to generate an energy signal. Specifically, when the first sensing coil 132a and the second sensing coil 132b receive the frequency signal Sf at the same time, the first sensing coil 132a and the second sensing coil 132b have the same frequency, so as to result in the electromagnetic resonance effect to generate an energy signal to the rectifying circuit 134. The rectifying circuit 134 receives the energy signal emitted from the sensing coils 132 to generate a required electric energy P. The sensing circuit 110 includes an oscillator circuit 114 and a sensing coil 112 (the third sensing coil). The sensing circuit 110 receives the electric energy P generated by the power supply circuit 130, generates a sensing signal Ss, and emits the sensing signal Ss to the tablet 200. Specifically, the oscillator circuit 114 receives the electric energy P generated by the power supply circuit 130 to generates the sensing signal Ss. The sensing coil 112 is connected with the oscillator circuit 114, and emits the sensing signal Ss generated by the oscillator circuit 114 to the tablet 200.

The tablet 200 at least includes a signal processing circuit 250, a first antenna loop 210, and a second antenna loop 230. The signal processing circuit 250 generates a frequency signal Sf, and determines a current coordinate position of the wireless pointing device 100 according to the sensing signal Ss emitted from the wireless pointing device 100. The first antenna loop 210 emits the frequency signal Sf. The second antenna loop 230 wirelessly receives the sensing signal Ss.

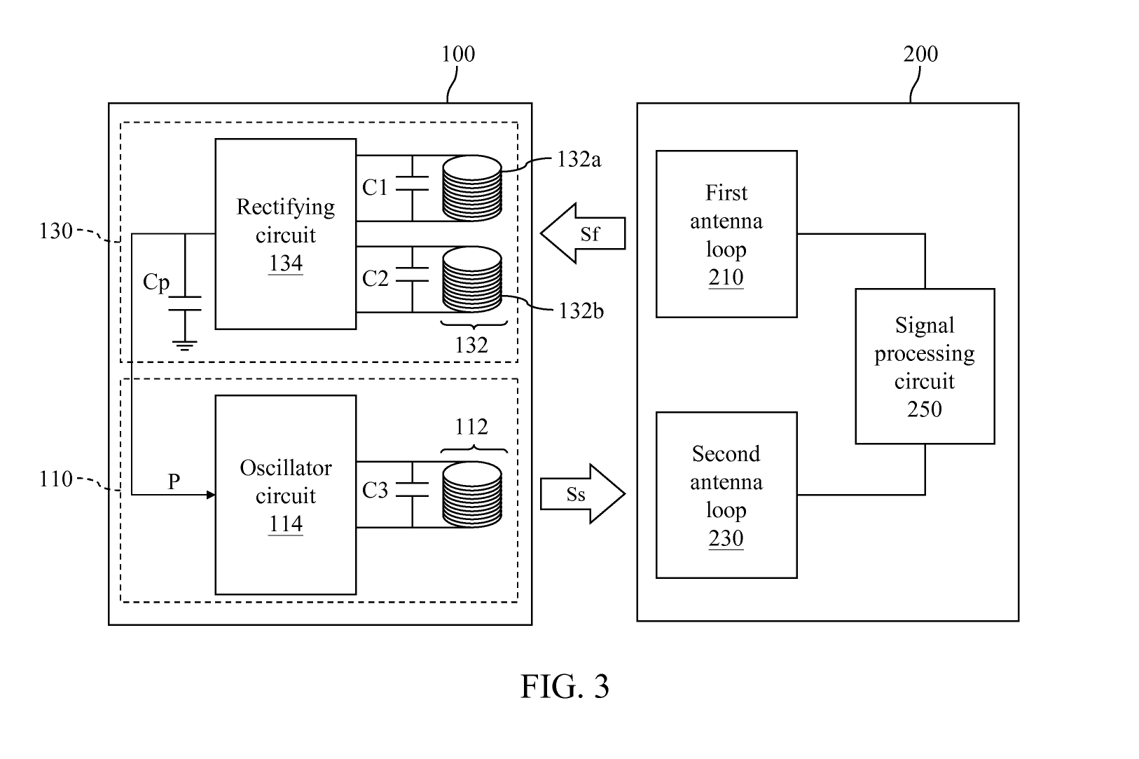

FIG. 3 is a schematic view of circuit structures of the tablet and the wireless positioning device according to an embodiment of the disclosure. An energy storage capacitor Cp can be further disposed between the rectifying circuit 134 and the sensing circuit 110 as compared with the embodiment in FIG. 2. The energy storage capacitor Cp stores the electric energy P outputted by the rectifying circuit 134, so as to supply the electric energy P to the sensing circuit 110.

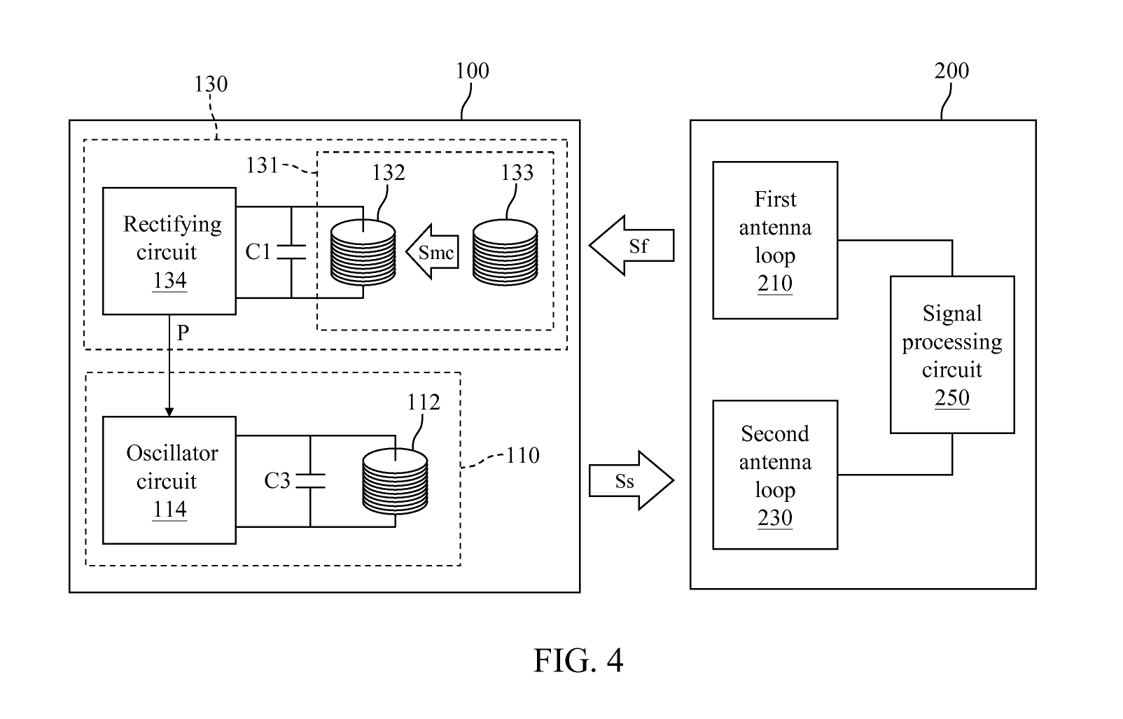

FIG. 4 is a schematic diagram of circuit structures of a tablet and a wireless positioning device according to an embodiment of the disclosure. Difference between the embodiments in FIG. 2 and FIG. 4 is that the power supply circuit 130 in FIG. 4 further includes a sensing coil 133 (the first sensing coil) pairing with the sensing coil 132 (the sensing coil set 131).

The sensing coil 133 is non-connected, and is parallel to the sensing coil 132. The operation and connection relation among the rectifying circuit 134, the first capacitor C1, the sensing circuit 110 and the tablet 200 in FIG. 4 are the same as those in FIG. 2.

In this and some embodiments, the disposition of the sensing coils 132 and 133 can be designed according to the type of the wireless positioning device 100 or the space inside the wireless positioning device 100. A quantity of the sensing coils in the sensing coil set 131 can be designed according to the electricity required by the wireless positioning device 100. The sensing coil in the disclosure can be formed by winding a certain number of coil wrappings around an outer surface of a metallic conductor, so that the sensing coil can generate an induced voltage by detecting the magnetic flux variation. When a current flowing through one of the sensing coils is changed, the flux linkage variation of the sensing coil is linked to the other sensing coil, so that the other sensing coil inducts magnetism to form a voltage. This phenomenon is called the magnetic coupling (or the instrument). The number of turns of the sensing coil 133 and that of the sensing coil 132 are in a certain proportion.

When the wireless positioning device 100 moves in a sensing range of the tablet 200, the sensing coil 133 inducts the frequency signal Sf to output a magnetic coupling signal Smc. Simultaneously, the sensing coil 132 inducts the frequency signal Sf and the magnetic coupling signal Smc to output electricity. Because the magnetic coupling signal Smc outputted by the sensing coil 133 will increase the magnetic flux of the sensing coil 132, the electricity outputted by the sensing coil 132 can also be increased.

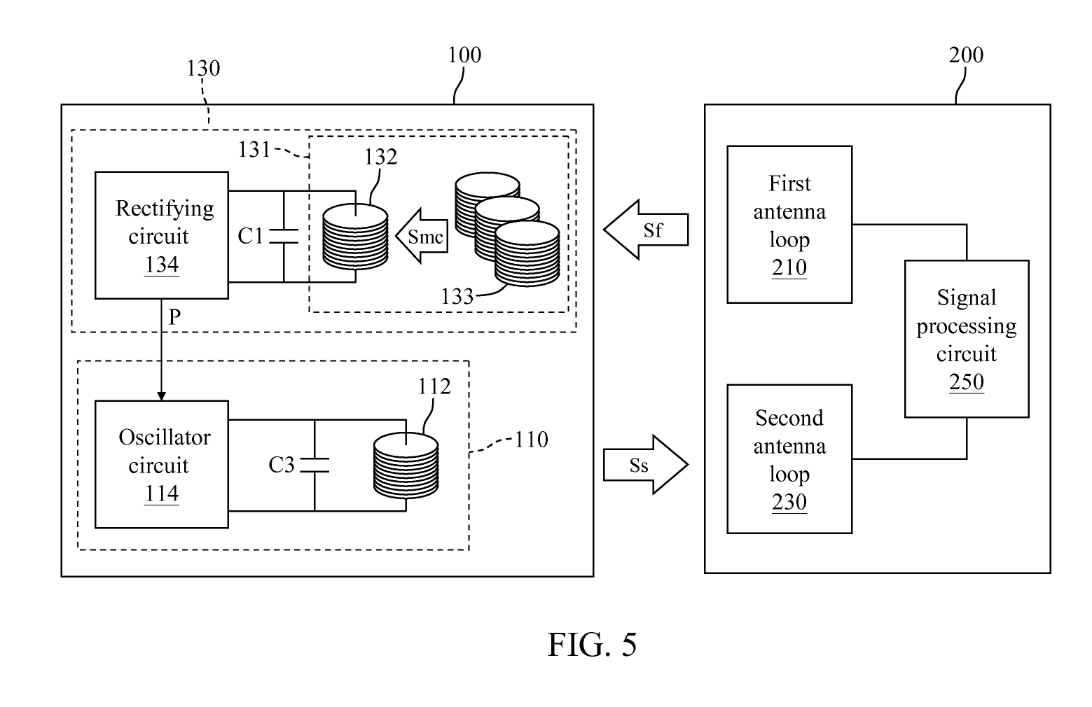

For example, the ratio of the number of turns of the sensing coil 133 to the number of turns of the sensing coil 132 is m:n, and m and n are natural numbers. In the disclosure, a plurality of sensing coils 133 can be disposed as shown in FIG. 5.

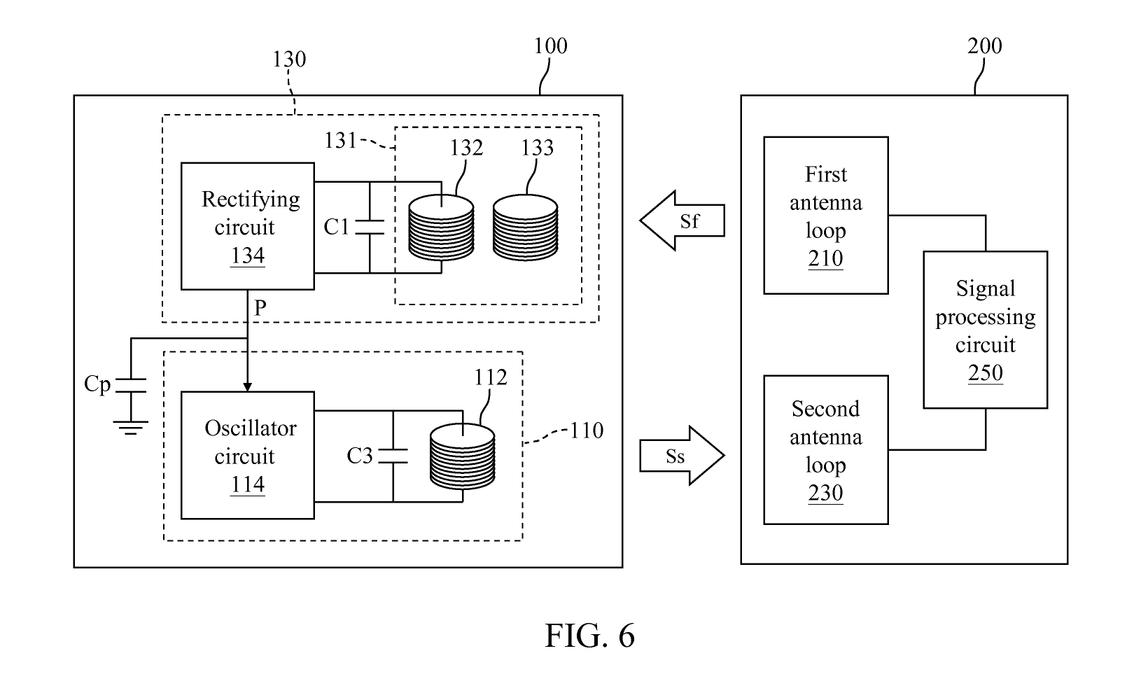

FIG. 6 is a schematic diagram of circuit structures of a tablet and a wireless positioning device according to an embodiment of the disclosure. Difference between the embodiments in FIG. 4 and FIG. 6 is that an energy storage capacitor Cp is further disposed between the rectifier circuit 134 and the oscillator circuit 114 in the wireless positioning device 100 in FIG. 6.

When the rectifier circuit 134 outputs the electric energy P to the sensing circuit 110, the energy storage capacitor Cp can store a part of the electric energy P passing through the energy storage capacitor Cp. When the wireless positioning device 100 is out of a sensing range of the tablet 200, the wireless positioning device 100 can still supply the operation power required by the sensing circuit 110.

The positioning input system with a wireless charging function in the disclosure can charge the wireless positioning device to supply the stable operation voltage required by the wireless positioning device, and also increases a voltage of the wireless pointing device.

What is claimed is:

1. A positioning input system with a wireless charging function, comprising:
a tablet used for computing a corresponding coordinate location according to an sensing signal, and the tablet comprising:
a signal processing circuit used for outputting a frequency signal;
a first antenna loop electrically connected to the signal processing circuit, for transmitting the frequency signal; and
a second antenna loop electrically connected to the signal processing circuit, for receiving the sensing signal; and
a wireless positioning device used for generating the sensing signal according to the frequency signal, and the wireless positioning device comprising:
a sensing coil set comprising at least one first sensing coil and a second sensing coil, the first sensing coil inducting the frequency signal to output a magnetic coupling signal, and the second sensing coil inducting the frequency signal and the magnetic coupling signal to output electricity;
a rectifier circuit used for receiving the frequency signal and the electricity through the sensing coil set;
an oscillator circuit electrically connected to the rectifier circuit, the oscillator circuit being used for receiving the electricity outputted by the rectifier circuit, and for outputting the sensing signal; and
a third sensing coil electrically connected to the oscillator circuit, the third sensing coil being used for transmitting the sensing signal.

2. The positioning input system according to claim 1, wherein the first sensing coil and the second sensing coil are parallel to each other, and the first sensing coil is non-connected.

3. The positioning input system according to claim 1, wherein the wireless positioning device further comprises an energy storage capacitor connected between the rectifier circuit and the oscillator circuit, for storing the electricity.

4. The positioning input system according to claim 1, wherein the wireless positioning device is a wireless positioning pen or a wireless mouse.

5. A positioning input device with a wireless charging function, for being charged according to a frequency signal sent by a tablet, the positioning input device comprising:
a sensing coil set comprising at least one first sensing coil and a second sensing coil, the first sensing coil inducting the frequency signal to output a magnetic coupling signal, the second sensing coil inducting the frequency signal and the magnetic coupling signal for outputting electricity;
a rectifier circuit, for receiving the frequency signal and the electricity through the sensing coil set; and
an oscillator circuit electrically connected to the rectifier circuit, for receiving the electricity outputted by the rectifier circuit.

6. The positioning input device according to claim 5, further comprising a third sensing coil electrically connected to the oscillator circuit, for transmitting an sensing signal to the tablet, the tablet determining a coordinate location of the positioning input device on the tablet according to the sensing signal.

7. The positioning input device according claim 5, further comprising an energy storage capacitor connected between the rectifier circuit and the oscillator circuit, for storing the electricity.

8. The positioning input device according to claim 5, wherein a first capacitor is coupled between two ends of the sensing coil set, a second capacitor is coupled between two ends of a third sensing coil which is electrically connected to the oscillator circuit and is used for transmitting the sensing signal.

9. The positioning input device according claim 5, wherein the first sensing coil and the second sensing coil are parallel to each other, and the first sensing coil is non-connected.

10. The positioning input device according to claim 5, wherein the positioning input device is a wireless positioning pen or a wireless mouse.
